(19) United States
(12) Patent Application Publication
(10) Pub. No.: US 2024/0057503 A1
(43) Pub. Date: Feb. 22, 2024

(54) WINDROW DETECTION DEVICE

(71) Applicant: CLAAS E-Systems GmbH, Dissen a.T.W. (DE)

(72) Inventors: Torben Töniges, Bielefeld (DE); Axel Schröder, Gütersloh (DE); Jannik Redenius, Oldendorf (DE); Stefan Linke, Rheda-Wiedenbrück (DE)

(73) Assignee: CLAAS E-Systems GmbH, Dissen a.T.W. (DE)

(21) Appl. No.: 18/234,487

(22) Filed: Aug. 16, 2023

(30) Foreign Application Priority Data
Aug. 16, 2022 (DE) 10 2022 120 618.1

(51) Int. Cl. A01B 69/04; A01B 69/00

(52) U.S. Cl. CPC A01B 69/008; A01B 69/001

(57) ABSTRACT

A device for detecting a windrow deposited on an agricultural area to be worked is disclosed. The device includes a camera configured to generate an image of the windrow deposited on the agricultural area and a computing unit that is configured to use artificial intelligence in order to evaluate the image. The artificial intelligence may be configured to identify a harvested material windrow in the image. The computing unit may be configured to determine a position of the harvested material windrow on the agricultural area to be worked.

### CROSS REFERENCE TO RELATED APPLICATION

This application claims priority under 35 U.S.C. § 119 to German Patent Application No. DE 10 2022 120 618.1 filed Aug. 16, 2022, the entire disclosure of which is hereby incorporated by reference herein.

### TECHNICAL FIELD

The present invention relates to a device for detecting a windrow deposited on an agricultural area to be worked.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

U.S. Pat. No. 6,389,785, incorporated by reference herein in its entirety, discloses a contour scanning apparatus for agricultural machine. Specifically, U.S. Pat. No. 6,389,785 discloses a laser scanner which, mounted just under the roof of a driver's cab of an agricultural vehicle, emits a laser beam along a forward-sloping plane and creates a height profile of a surface lying in front of the vehicle by measuring the distance to the next object reflecting the laser beam. Each scan of the laser beam along the plane may provide a height profile along a line running transverse to the direction of travel.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates a schematic side view of a forage harvester;

FIG. 2 illustrates a picture taken by a camera of the forage harvester;

FIG. 3 illustrates the image of FIG. 2 after running through semantic segmentation and evaluation of the segmentation results; and

FIG. 4 illustrates an interim result of the evaluation.

### DETAILED DESCRIPTION

As discussed in the background, the scan of the laser beam along the plane may provide a height profile along a line running transverse to the direction of travel. For a windrow to be reliably detectable, the highest point in successively recorded height profiles may be found at approximately the same point. Irregularities resulting from fluctuations in the mass flow when depositing the windrow or from unevenness of the ground may impair windrow detection. In one or some embodiments, a windrow is a row of cut (or mown) hay or small grain crop. In one or some embodiments, the hay or crop may be allowed to dry before being baled, combined, or rolled.

In order to achieve a more reliable windrow detection, a device is disclosed that is configured to detect a windrow deposited on an agricultural area to be worked. The device includes a camera configured to generate one or more images of the windrow deposited on the agricultural area, and a computing unit that is configured to use artificial intelligence (AI) for evaluating the image. In particular, the AI may be configured to identify a harvested material windrow in the image. Responsive to the identification by the AI of the harvested material windrow in the image, the computing unit is configured to determine a position (e.g., the physical position or location) of the harvested material windrow (interchangeably termed windrow) on the agricultural area to be worked.

In one or some embodiments, since the AI may evaluate patterns formed such as on the surface of the windrow by the material contained therein, purely two-dimensional image information may be sufficient. In this regard, a conventional electronic camera with a two-dimensional image sensor may be used in the device, with the image generated including pixels each of which may provide only brightness and possibly hue information, but not depth information representative of the distance of the pixelated object from the camera.

In one or some embodiments, the AI may comprise a trained neural network, such as of the residual neural network type (e.g., a model of DeepLab series, an example of which is DeepLab V3+). Code for such networks is available on the Internet, such as at www.mathworks.com. Various embodiments of these networks differ in terms of the number of levels in which the nodes of the network are arranged. In particular, a Resnet18 architecture has proven suitable for the purposes of the invention. Techniques for training such neural networks using images in which the semantic classes of individual image areas are known in advance are familiar to those skilled in the art; for training a network to recognize a “windrow” class, it may therefore be sufficient to provide a sufficient number of images in which it is already known which image areas show a windrow and which do not. In this regard, in one or some embodiments, supervised learning may be used, such as by identifying within the training images (e.g., images used for training the neural network) where the windrow resides.

In one or some embodiments, image areas showing no windrow may belong to different classes, such as “sky” and “windrow-free ground area”. In one or some embodiments, it is sufficient to distinguish between the classes “windrow” on the one hand and “non-windrow” or “background” on the other hand.

In one or some embodiments, it may not be necessary to always perform the semantic segmentation for a complete image of the camera. In fact, the computing unit may be configured to extract at least a portion of the image (e.g., a subpart of the image) whose image contents are reachable by a self-propelled machine carrying the device according to one aspect of the invention in a limited period of time, typically a part at the bottom of the image. For a part of the image whose contents are further away from the machine, segmentation may be deferred until the distance is reduced and a higher-resolution image information is available.

In particular, the computing unit may be configured to extract at least a part of the image which, when the device is installed on a vehicle, shows a part of the agricultural area to be worked along a path of the vehicle extrapolated when traveling straight ahead and on either side of the extrapolated path. It may thereby be possible to ensure that the windrow extends not only along the extrapolated path but also laterally from it which, if the machine is to navigate autonomously along the windrow, allows the path to be automatically identified using the images from the camera (and in turn the agricultural machine may be automatically steered accordingly, such as to autonomously navigate along or relative to the windrow).

In one or some embodiments, for automatic determination of the path, the computing unit may be configured to automatically determine one or more points of a left edge and a right edge of a windrow identified in the extracted image part, and may further be configured to automatically determine a path to be traveled by the vehicle based on the determined points (and in turn be configured to automatically control the vehicle to automatically travel along the determined path).

In one or some embodiments, in making the determination of the path, the computing unit may automatically determine a plurality of center points between opposing points of the left and right edges of the windrow and may automatically adjust a compensation curve to the determined center points.

Based on the compensation curve, the computing unit may automatically select at least one point on the agricultural area to be worked and may automatically select a direction of travel. In turn, the computing unit may automatically control the vehicle, such as automatically control steering of the vehicle, so that the vehicle drives over the point with the selected direction of travel. In this regard, the vehicle may be automatically controlled in one or both of the following: the point (e.g., the geographic position); and the direction at which the point is driven over. Typically, the selected point may be on the compensation curve, and the selected direction of travel may be tangential to the direction of travel. By repeating the selection of the point and direction of travel with sufficient frequency, the vehicle may follow the compensation curve with high accuracy. This does not necessarily exclude that the compensation curve is continuously updated while driving, especially by using high-resolution image information that may become available during driving.

In one or some embodiments, the computing unit may consider or take into account the limitations of the vehicle (e.g., the turning circle of the agricultural vehicle). For example, taking into account the turning circle typical for agricultural vehicles such as a self-propelled baler, the computing unit may select the point at a distance from the vehicle between 2 and 10 m. In this way, the agricultural vehicle may operate within its limits of the turning circle while still being able to drive over the point with the selected direction of travel.

Thus, in one or some embodiments, a vehicle (e.g., an agricultural vehicle), such as a forage harvester or a self-propelled baler, with a device for detecting a windrow as described above, is disclosed.

Further, in one or some embodiments, a computer program comprising program instructions which, when executed on a computer, enable said computer to function as a computing unit in an apparatus as described above, is disclosed.

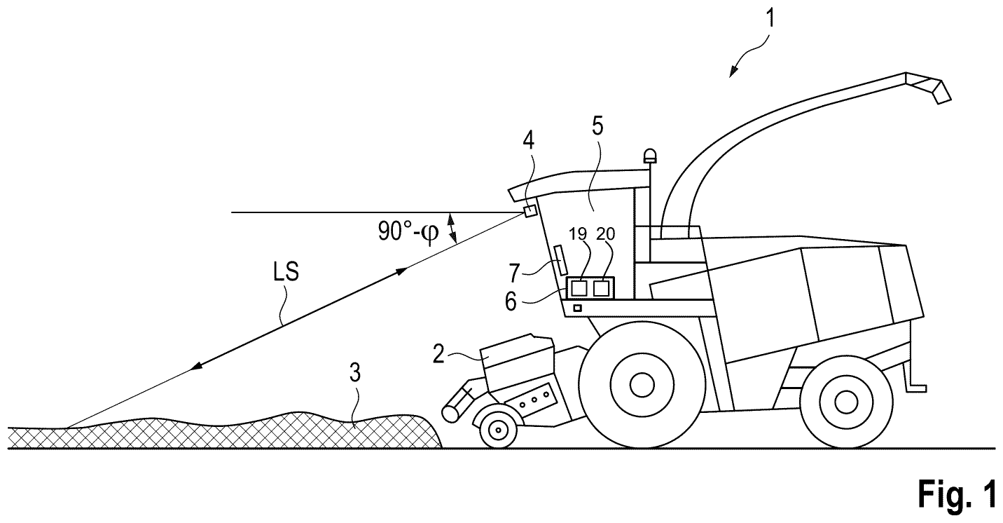

Referring to the figures, FIG. 1 shows a forage harvester 1 with a pickup 2 as an attachment for picking up harvested material lying in a windrow 3. An example of a forage harvester 1 is disclosed in US Patent Application Publication No. 2023/0232740 A1, incorporated by reference herein in its entirety. Alternatively, a baler may be used, such as disclosed in US Patent Application Publication No. 2023/0084503 A1 and US Patent Application Publication No. 2019/0090430 A1, both of which are incorporated by reference herein in their entirety.

A camera 4 is mounted on the front edge of a roof of a driver's cab 5 (interchangeably termed an operator cab) to monitor the field area lying in front of the forage harvester 1 with the windrow 3 thereupon. In this regard, the camera 4 is mounted or positioned in fixed relation to the driver's cab 5. An on-board computer 6 is connected to (e.g., in communication with) the camera 4 and configured to receive images taken by the camera 4, and to semantically segment them using a neural network (e.g. to decide, for each pixel of at least a part of the images, whether or not the pixel belongs to a windrow). In one or some embodiments, image areas that do not belong to a windrow are referred to as background in the following, regardless of the type of object they belong to and how the distance of this object from the camera relates to the distance of a windrow visible in the same image from the camera.

The on-board computer 6 may include at least one processor 19 and at least one memory 20 that stores information (e.g., the neural network) and/or software, with the processor 19 configured to execute the software stored in the memory 20 (e.g., the memory 20 comprises a non-transitory computer-readable medium that stores instructions that when executed by processor 19 performs any one, any combination, or all of the functions described herein). In this regard, the on-board computer 6 may comprise any type of computing functionality, such as the at least one processor 19 (which may comprise a microprocessor, controller, PLA, or the like) and the at least one memory 20. The memory 20 may comprise any type of storage device (e.g., any type of memory). Though the processor 19 and the memory 20 are depicted as separate elements, they may be part of a single machine, which includes a microprocessor (or other type of controller) and a memory. Alternatively, the processor 19 may rely on memory 20 for all of its memory needs.

The processor 19 and memory 20 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

For segmentation, the on-board computer 6 may use a model of the type DeepLabv3+, which is known per se and was developed by Google, Inc., such as for applications for recognizing other road users in autonomous driving in road traffic. For example, DeepLabv3+ is an example of a semantic segmentation architecture. To handle the problem of segmenting objects at multiple scales, modules may be designed which may employ atrous convolution in cascade or in parallel to capture multi-scale context by adopting multiple atrous rates. Furthermore, the Atrous Spatial Pyramid Pooling module from DeepLabv2 may be augmented with image-level features encoding global context and further boost performance.

In one or some embodiments, the model may use the technique of spatial pyramid pooling to be able to correctly assess the semantic content of an image area even at different image resolutions and consequently to be able to recognize the windrow 3 not only in the immediate vicinity of the forage harvester 1 where high-resolution image information, possibly resolving individual plant parts of the windrow, is available, but also at a greater distance, where the resolution of the camera may no longer be sufficient for such details. An also-implemented encoder-decoder structure of the network may enable the identification of sharp object boundaries in the image, and thereby may support the identification of individual plant parts and the classification of an image area as a windrow or background based on this identification. In one or some embodiments, the encoder may use a Resnet-18 architecture.

A screen 7 for displaying results of processing by the on-board computer 6 may be provided in the driver's cab 5. In one or some embodiments, the screen 7 is a touchscreen.

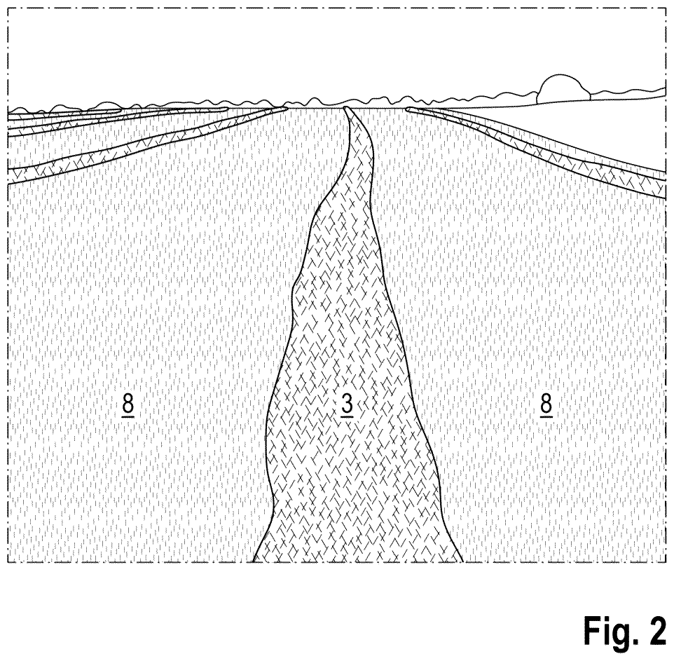

FIG. 2 shows an example of an image taken by camera 4 of an acreage lying in front of forage harvester 1. The area has been harvested, and on a large part of the area, the stubble standing upright in rows forms a characteristic surface pattern which enables the on-board computer 6 to identify these areas as background 8 not belonging to a windrow. A windrow 3 extends to the horizon immediately from the forage harvester 1. In the figure, the windrow 3 is shown schematically as a pattern of short dashes accordingly oriented differently than the stalks lying randomly in the windrow. In reality, the randomly oriented stalks are only visible in the images of the camera 4 in the vicinity of the forage harvester 1, at the lower edge of the image. At a greater distance from camera 4, the stalks are no longer resolved in the images; here, the windrow 3 is recognizable by randomly distributed dark zones where camera 4 always looks into a shaded hollow space between the stalks of the windrow.

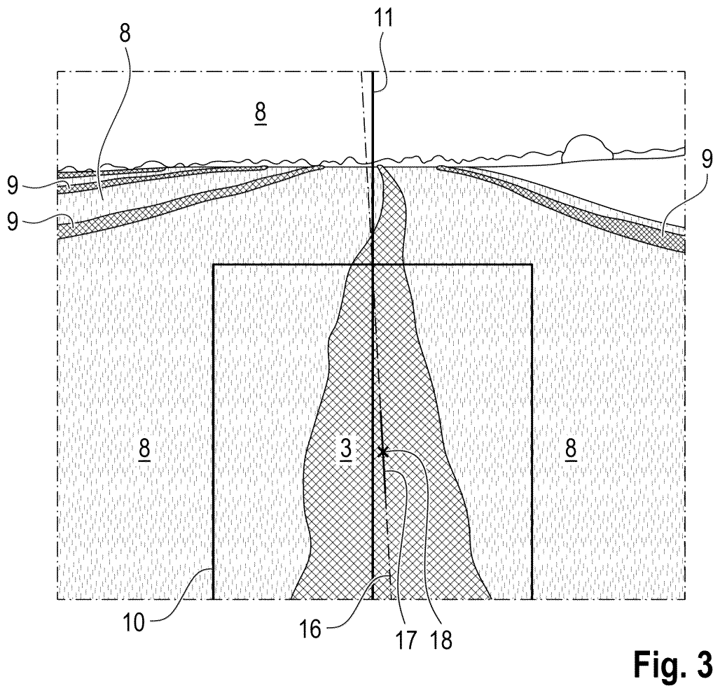

FIG. 3 shows the result of processing the image by the on-board computer 6. The results of a semantic segmentation performed by the neural network implemented in the on-board computer 6 are illustrated here by cross-hatching image regions identified as belonging to a windrow 3. In practice, when the result of the semantic segmentation is displayed on the screen 7, the windrow 3 may be shown in an unnatural color, such as a shade of red, while image parts identified as belonging to the background 8 are shown in their natural color as captured by the camera 4. In this regard, the on-board computer 6 may modify at least a part of the image, such as the underlying image in one or more ways, such as using one or both of: (i) modifying at least one aspect of the underlying image itself (e.g., by modifying the colors of at least a part of the image, such as to indicate the windrow 3); or (ii) adding or superimposing a feature on the underlying image (e.g., by superimposing an arrow, box or the like onto the image). This may comprise one or more ways in which to highlight the identified windrow(s). Thus, maintaining the natural color in the larger part of the image may make it easier for a driver to understand the image when it is displayed on the screen 7.

In the illustration of FIG. 3, the semantic segmentation has been performed for the entire image of the camera; several image areas separated from each other are marked as windrows 3, 9, including those that are not located directly from the forage harvester 1. It is evident that information about windrow 9 displaced sideways relative to the current position of the forage harvester 1 is not needed for autonomous navigation along a windrow, at least when a windrow 3 lying directly in front of the forage harvester 1 is visible. Thus, in one or some embodiments, the on-board computer 6 may automatically identify the windrow 3 that is lying directly in front of the forage harvester 1 and automatically navigate accordingly. In this regard, the on-board computer 6 may discount, or not consider the other windrow(s) 9 that are identified in the image. As one example, the on-board computer 6 may determine whether any windrows, such as windrow 3, is located within subarea 10. As another example, the on-board computer 6 may first identify the windrows 3, 9 within the image, and the determine whether the identified windrows 3, 9 are located within subarea 10, and if so, identify the windrow 3 as lying directly in front of the forage harvester 1.

Therefore, in one or some embodiments, in the field, the automatic semantic analysis may be limited, at least initially, to a subarea 10 of the image that is centered adjacent to the bottom edge of the image and thus shows the part of the field area to be traveled next by the forage harvester 1. If the semantic segmentation identifies the windrow 3 in this subarea 10, segmentation of the rest of the image may be omitted; only if no windrow is found, it may be necessary to segment further image areas adjacent to the subarea 10 (or expand subarea 10) until a windrow is found.

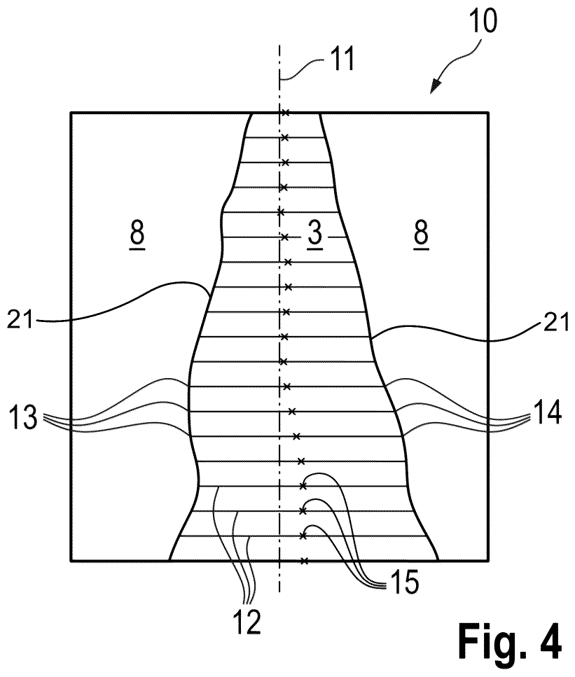

FIG. 4 illustrates the further processing of the segmentation results using an enlarged view of subarea 10. The windrow 3 and the background 8 are each shown here as white areas; boundaries 21 between them are drawn as irregularly curved black lines. When traveling straight ahead, the forage harvester 1 would automatically move across the depicted field area along a line 11 running in the middle between lateral edges of the subarea 10. Perpendicular to this line, the on-board computer 6 may automatically construct a plurality of lines 12, and may automatically determine crossing points 13, 14 at which these lines 12 cross the left and right boundaries of the image of windrow 3, as well as a point 15 lying in the middle between each of the two crossing points 13, 14.

In the next step, the on-board computer 6 may automatically calculate (e.g. according to the well-known least squares method) a balancing polynomial through the points 15. Here, the line 11 corresponds to an axis on which the argument of the polynomial is plotted; the value of the polynomial for a given argument may denote the distance of a point of the polynomial from the line 11. The polynomial may be of odd order, such as of first order (i.e., a straight line) or of third order.

As shown in FIG. 4, the lines 12 may be evenly spaced in the subarea 10. If these lines 12 were projected onto the acreage along the viewing direction of the camera 4, the distance between the projected lines would increase with increasing distance from the camera 4. Parts of the windrow 3 lying close to the camera 4 therefore may enter into the calculation of the polynomial with a greater weight than areas that are far away, thus in a completely desirable manner.

As an example, the polynomial calculated in this way is shown as a dashed curve 16 in the display image of FIG. 3. On the screen 7, it may be sufficient if only a short section 17 of the curve 16 is shown, from which at least one point 18 of the curve 16 and the direction of the curve 16 at this point 18 may be recognized. Thus, in one or some embodiments, curve 16 may comprise the recommended path. Alternatively, the recommended path may be based on curve 16. In the case of FIG. 3, this section 17 is offset to the right from the line 11 and runs upward toward the line 11. A driver may therefore immediately recognize from the display image that, in order to drive section 17 or to drive over the point in the direction indicated by section 17, he/she must first steer the forage harvester to the right and then back onto line 11; it is evident that the on-board computer 6 may also make corresponding calculations to steer the forage harvester 1 autonomously along section 17. In this regard, in one embodiment, the on-board computer 6, using the screen 7, automatically outputs the indication for steering, which the driver may then manually perform. Alternatively, the on-board computer 6 may perform one or both of: using the screen 7, automatically output the indication for steering; and/or automatically steer the forage harvester 1 according to the indication without driver input.

Thus, in one or some embodiments, the display may output an image which includes one or both of: (i) a direction of travel and/or future point of the forage harvester 1 without modification (see line 11); and (ii) a suggested direction of travel and/or future point for the forage harvester 1 with modification to account for the windrow 3 (see curve 16, point 18). In this regard, the operator may be automatically provided with the information in order to steer the forage harvester 1 as recommended by the on-board computer 6.

In one or some embodiments, to allow such a maneuver without excessive steering movements, the distance of the section 17 or point 18 from the forage harvester 1 should not be less than the turning circle diameter of the forage harvester 1, but need not be greater than a multiple of this diameter. Typically, the distance is between 2 and 10 m.

In one or some embodiments, the on-board computer 6 may continuously repeat the calculation of the section 17. By the on-board computer 6 continuously repeating the calculation of the section 17 and controlling the steering based thereupon, the windrow 3 may be driven autonomously along part or all of its entire length.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Forage harvester
2 Pickup
3 Windrow
4 Camera
5 Driver's cab
6 On-board computer
7 Screen
8 Background
9 Windrow
10 Subarea
11 Line
12 Line
13 Point
14 Point
15 Center points
16 Curve
17 Section
18 Point
19 Processor
20 Memory
21 Boundary

1. A device configured to detect a windrow deposited on an agricultural area to be worked, the device comprising:
a camera configured to generate an image of the windrow deposited on the agricultural area; and
a computing unit configured to:
evaluate the image using artificial intelligence, wherein the artificial intelligence is configured to identify a harvested material windrow in the image; and
determine, based on the identified harvested material windrow in the image, a position of the harvested material windrow on the agricultural area to be worked.

2. The device of claim 1, wherein the artificial intelligence comprises a neural network; and
wherein the neural network is trained to perform, for at least part of the image, a semantic segmentation that assigns to one or more pixels in the image a class windrow or at least one class different from the class windrow.

3. The device of claim 2, wherein the trained neural network comprises a Residual Neural Network type.

4. The device of claim 2, wherein the neural network is configured to use a model of DeepLab series for semantic segmentation.

5. The device of claim 1, wherein the computing unit is configured to:
analyze at least a subpart of the image which, responsive to the device being installed on an agricultural vehicle, illustrates a part of the agricultural area to be worked along a path of the agricultural vehicle extrapolated when traveling straight ahead and illustrates on either side of the extrapolated path; and
perform one or both of:
modify one or both of the at least the subpart of the image or the image; and
output on a display the modified one or both of the at least the subpart of the image or the image; or
automatically control the agricultural vehicle based on the analysis of the at least the subpart of the image.

6. The device of claim 5, wherein the computing unit is configured to:
determine a plurality of points at a left and a right edge of a windrow identified in the part of the agricultural area;
determine a recommended path to be traveled by the agricultural vehicle based on the plurality of points; and
perform one or both of:
output on the display at least a part of the recommended path superimposed on the at least the subpart of the image; or
automatically control the agricultural vehicle to follow the recommended path.

7. The device of claim 6, wherein the computing unit is further configured to determine a plurality of center points between the plurality of points at the left and right edges of the windrow; and
wherein the computing unit is configured to determine the recommended path to be traveled by the agricultural vehicle by adapting a compensation curve to the plurality of center points.

8. The device of claim 7, wherein the computing unit is configured to:
select, based on the compensation curve, at least one point on the agricultural area to be worked and a direction of travel; and
automatically control steering of the agricultural vehicle so that the agricultural vehicle drives over the point with the direction of travel selected.

9. The device of claim 8, wherein the computing unit is configured to select the at least one point based on at least one aspect of the agricultural vehicle.

10. The device of claim 9, wherein the at least one aspect of the agricultural vehicle comprises a turning circle of the agricultural vehicle so that the agricultural vehicle is automatically operated to steer the agricultural vehicle with the turning circle so that the agricultural vehicle automatically drives over the at least one point with the direction of travel selected.

11. The device of claim 5, wherein the computing unit is configured to modify the one or both of the at least the subpart of the image or the image by:
altering color in the one or both of the at least the subpart of the image in order to highlight at least one windrow.

12. The device of claim 11, wherein the agricultural vehicle is configured to travel in a path; and
wherein the computing unit is configured to highlight the at least one windrow in the path of the travel of the agricultural vehicle.

13. The device of claim 12, wherein the computing unit is configured to highlight only the at least one windrow in the path of the travel of the agricultural vehicle.

14. An agricultural vehicle comprising:
an operator cab; and
a device configured to detect a windrow deposited on an agricultural area to be worked by the agricultural vehicle, the device comprising:
a camera positioned in fixed relation to the operator cab, the camera configured to generate an image of the windrow deposited on the agricultural area; and
a computing unit configured to:
evaluate the image using artificial intelligence, wherein the artificial intelligence is configured to identify a harvested material windrow in the image; and
determine, based on the identified harvested material windrow in the image, a position of the harvested material windrow on the agricultural area to be worked.

15. The agricultural vehicle of claim 14, wherein the computing unit is configured to:
extract at least a subpart of the image which, responsive to the device being installed on an agricultural vehicle, illustrates a part of the agricultural area to be worked along a path of the agricultural vehicle extrapolated when traveling straight ahead and illustrates on either side of the extrapolated path;
analyze the at least the subpart of the image; and
perform one or both of:
modify one or both of the at least the subpart of the image or the image; and
output on a display the modified one or both of the at least the subpart of the image or the image; or
automatically control the agricultural vehicle based on the analysis of the at least the subpart of the image.

16. The agricultural vehicle of claim 15, wherein the computing unit is configured to:
determine a plurality of points at a left and a right edge of a windrow identified in the part of the agricultural area; and
determine a recommended path to be traveled by the agricultural vehicle based on the plurality of points.

17. The agricultural vehicle of claim 16, wherein the computing unit is further configured to determine a plurality of center points between the plurality of points at the left and right edges of the windrow; and
wherein the computing unit is configured to determine the recommended path to be traveled by the agricultural vehicle by adapting a compensation curve to the plurality of center points.

18. A non-transitory computer-readable medium comprising instructions stored thereon, that when executed on at least one processor, perform the steps of:
receiving an image, generated by at least one camera, of a windrow deposited on an agricultural area;
evaluating the image using artificial intelligence, wherein the artificial intelligence is configured to identify a harvested material windrow in the image; and
determining, based on the identified harvested material windrow in the image, a position of the harvested material windrow on the agricultural area to be worked by an agricultural vehicle.

19. The non-transitory computer-readable medium of claim 18, wherein the instructions when executed on the at least one processor perform:
analyzing at least a subpart of the image which, responsive to a device for detecting windrows being installed on the agricultural vehicle, illustrates a part of the agricultural area to be worked along a path of the agricultural vehicle extrapolated when traveling straight ahead and illustrates on either side of the extrapolated path; and
performing one or both of:
modifying one or both of the at least the subpart of the image or the image; and
outputting on a display the modified one or both of the at least the subpart of the image or the image; or
automatically control the agricultural vehicle based on the analysis of the at least the subpart of the image.

20. The non-transitory computer-readable medium of claim 19, wherein the instructions when executed on the at least one processor perform:
determining a plurality of points at a left and a right edge of the windrow identified in the part of the agricultural area; and
determine a recommended path to be traveled by the agricultural vehicle based on the plurality of points.
